(19) United States
(12) Patent Application Publication
(10) Pub. No.: US 2026/0339037 A1
(43) Pub. Date: Oct. 29, 2026

(54) OPTICAL COUPLING ASSEMBLY AND MANUFACTURING METHOD THEREOF

(71) Applicant: UNIMICRON TECHNOLOGY CORP., Taoyuan City (TW)

(72) Inventors: Chia-Yu PENG, Taoyuan City (TW); Pu-Ju LIN, Taoyuan City (TW); Kai-Ming YANG, Taoyuan City (TW); Cheng-Ta KO, Taoyuan City (TW)

(73) Assignee: UNIMICRON TECHNOLOGY CORP., Taoyuan City (TW)

(21) Appl. No.: 19/232,129

(22) Filed: Jun. 9, 2025

(30) Foreign Application Priority Data
Apr. 23, 2025 (TW) 114115385

(51) Int. Cl. G02B 6/36

(52) U.S. Cl. CPC G02B 6/3636; G02B 6/3668

(57) ABSTRACT

An optical coupling assembly and a manufacturing method thereof. The optical coupling assembly includes at least one optical fiber array. The at least one optical fiber array includes a carrier substrate, a plurality of optical fibers, a first adhesive layer and a cover plate. The carrier substrate includes a positioning part and a supporting part connected to each other. The supporting part is higher than the positioning part. The optical fibers are arranged in layers on the positioning part. At least one of the plurality of optical fibers is supported by the supporting part. The first adhesive layer adheres the plurality of optical fibers to the carrier substrate. The cover plate is disposed on the first adhesive layer. At least a part of the first adhesive layer is located between the cover plate and the supporting part.

### CROSS-REFERENCE TO RELATED APPLICATIONS

This non-provisional application claims priority under 35 U.S.C. § 119(a) on Patent Application No(s). 114115385 filed in Taiwan, R.O.C. on Apr. 23rd , 2025 , the entire contents of which are hereby incorporated by reference.

### TECHNICAL FIELD

The disclosure relates to an optical coupling assembly and a manufacturing method thereof, more particularly to an optical coupling assembly including at least one optical fiber and a manufacturing method of the optical coupling assembly.

### BACKGROUND

In general, a Co-Packaged Optics (CPO) include an optical engine, and the optical engine includes at least one photonic integrated circuit (PIC) and at least one electronic integrated circuit (EIC). Optical signals enter into the PIC via optical fibers, and the EIC transfers the optical signals into electrical signals. Conventionally, the optical fibers are arranged in a single layer on the carrier to be optically coupled to the PIC.

However, such arrangement of the optical fibers limits the density of the optical paths in CPO. In other words, a limited number of optical fibers are allowed to be installed in conventional CPO, which further limits the application of CPO.

### SUMMARY

The disclosure provides an optical coupling assembly and a manufacturing method thereof, which include multiple layers of optical fibers to improve the density of the optical paths.

One embodiment of this disclosure provides an optical coupling assembly including at least one optical fiber array. The at least one optical fiber array includes a carrier substrate, a plurality of optical fibers, a first adhesive layer and a cover plate. The carrier substrate includes a positioning part and a supporting part connected to each other. The supporting part is higher than the positioning part. The optical fibers are arranged in layers on the positioning part. At least one of the plurality of optical fibers is supported by the supporting part. The first adhesive layer adheres the plurality of optical fibers to the carrier substrate. The cover plate is disposed on the first adhesive layer. At least a part of the first adhesive layer is located between the cover plate and the supporting part.

In an embodiment of the disclosure, the supporting part has a supporting surface. At least one of the plurality of optical fibers is supported by the supporting surface. Different layers of the plurality of optical fibers is aligned with each other along a direction perpendicular to a normal direction of the supporting surface.

In an embodiment of the disclosure, the positioning part has a plurality of positioning grooves. One of the layers of the plurality of optical fibers is held in position in the plurality of positioning grooves, respectively.

In an embodiment of the disclosure, the optical coupling assembly further includes a second adhesive layer. The positioning part and the supporting part together form a bottom surface. The bottom surface faces away from the plurality of optical fibers. The at least one optical fiber array includes two optical fiber arrays. The two bottom surfaces of the two carrier substrates of the two optical fiber arrays are adhered to each other via the second adhesive layer.

In an embodiment of the disclosure, there is an identical number of the plurality of optical fibers in different layers.

In an embodiment of the disclosure, there are different numbers of the plurality of optical fibers in different layers.

In an embodiment of the disclosure, a first layer of the plurality of optical fibers is located closer to the positioning part than a second layer of the plurality of optical fibers, and the first layer of the plurality of optical fibers is less than the second layer of the plurality of optical fibers.

In an embodiment of the disclosure, a first layer of the plurality of optical fibers is located closer to the positioning part than a second layer of the plurality of optical fibers, and at least one of the first layer of the plurality of optical fibers is aligned with at least one of the second layer of the plurality of optical fibers along a thickness direction of the carrier substrate.

In an embodiment of the disclosure, the optical coupling assembly further includes a waveguide. The waveguide includes at least one substrate, a cladding layer and a plurality of cores. The cladding layer is disposed on the substrate. The cores are disposed in the cladding layer and optically coupled to at least one of the plurality of optical fibers of the optical fiber array.

In an embodiment of the disclosure, the plurality of cores of the waveguide is optically coupled to the plurality of optical fibers, respectively.

In an embodiment of the disclosure, the plurality of cores of the waveguide is optically coupled to some layers of the plurality of optical fibers.

Another embodiment of this disclosure provides a manufacturing method of optical coupling assembly including providing a carrier substrate and processing the carrier substrate to include a positioning part and a supporting part connected to each other, wherein the supporting part is higher than the positioning part; adhering a plurality of optical fibers to the carrier substrate via a first adhesive layer, wherein the plurality of optical fibers is arranged in layers on the positioning part, and at least one of the plurality of optical fibers is supported by the supporting part; and disposing a cover plate on the first adhesive layer, wherein at least a part of the first adhesive layer is located between the cover plate and the supporting part.

In an embodiment of the disclosure, the manufacturing method of optical coupling assembly further includes providing a substrate; disposing a cladding layer on the substrate and disposing a plurality of cores in the cladding layer; and optically coupling the plurality of cores to at least one of the plurality of optical fibers.

In an embodiment of the disclosure, adhering the plurality of optical fibers to the carrier substrate via the first adhesive layer includes disposing a first sub adhesive layer on the carrier substrate; disposing a first layer of the plurality of optical fibers in the first sub adhesive layer partially so that the first layer of the plurality of optical fibers is disposed on the positioning part; disposing a second sub adhesive layer and a second layer of the plurality of optical fibers on the first sub adhesive layer and the first layer of the plurality of optical fibers; and disposing a third sub adhesive layer on the second sub adhesive layer and the second layer of the plurality of optical fibers.

According to the optical coupling assembly and the manufacturing method thereof disclosed by above embodiments, the optical fibers are arranged in layers on the positioning part, and at least one of the optical fibers is supported by the supporting part. Thus, the optical fiber array of the optical coupling assembly is allowed to include multiple layers of optical fibers while precisely ensuring the alignment of the optical fibers. Accordingly, the density of optical paths is improved while ensuring the reliability of the installation of the optical fibers.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIGS. 1-22 show a manufacturing method of an optical coupling assembly according to a first embodiment of the disclosure;

FIGS. 23 and 24 show an optical fiber array and a waveguide according to a second embodiment of the disclosure, respectively;

FIGS. 25 and 26 show an optical fiber array and a waveguide according to a third embodiment of the disclosure, respectively; and

FIGS. 27 and 28 show an optical fiber array and a waveguide according to a fourth embodiment of the disclosure, respectively.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

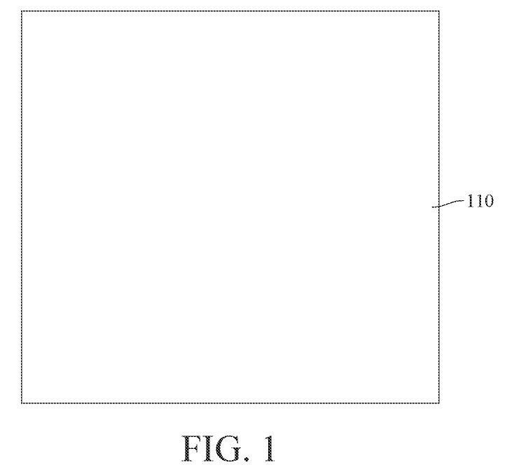

Hereinafter, a manufacturing method of an optical coupling assembly 10 according to a first embodiment of the disclosure will be described by referring to FIGS. 1-22. FIGS. 1-22 show the manufacturing method of the optical coupling assembly 10 according to the first embodiment of the disclosure. The manufacturing method of the optical coupling assembly 10 may include following steps.

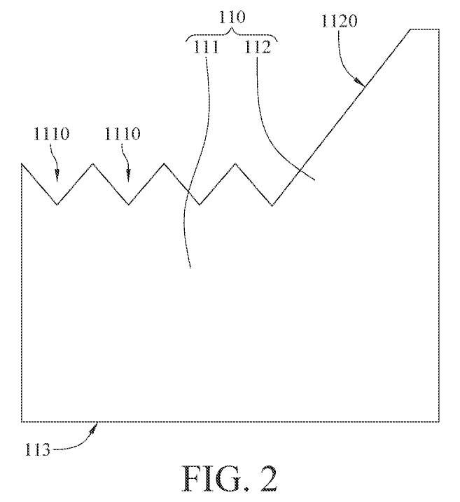

First, as shown in FIGS. 1 and 2, a carrier substrate 110 is provided and the carrier substrate 110 is processed by, for example, laser processing or machine processing to include a positioning part 111 and a supporting part 112 that are connected to each other. The supporting part 112 is higher than the positioning part 111. In detail, the positioning part 111 and the supporting part 112 together form a bottom surface 113. The supporting part 112 is higher than the positioning part 111 relative to the bottom surface 113. In addition, the positioning part 111 has a plurality of positioning grooves 1110. The positioning grooves 1110 are, for example, V-shaped. The supporting part 112 has a supporting surface 1120. The bottom surface 113 faces away from the positioning grooves 1110 and the supporting surface 1120. Furthermore, the carrier substrate 110 is made of, for example, glass, but the disclosure is not limited thereto. In other embodiments, the carrier substrate may be made of materials that are less prone to deformation, such as ceramic or silicon.

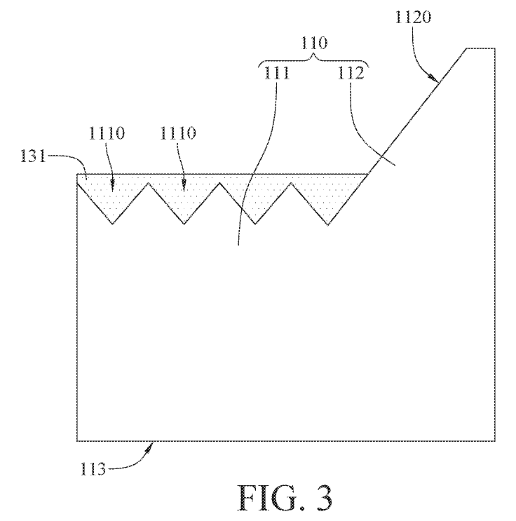

Then, as shown in FIGS. 3-8, a plurality of optical fibers 121 to 124 are adhered to the carrier substrate 110 via a first adhesive layer 130. In this embodiment, for example, the optical fibers 121 to 124 are adhered to the carrier substrate 110 via the first adhesive layer 130 in a layer-by-layer manner. That is, in this embodiment, the step of adhering the optical fibers 121 to 124 to the carrier substrate 110 via the first adhesive layer 130 includes, for example, following steps.

Firstly, as shown in FIG. 3, a first sub adhesive layer 131 is disposed on the carrier substrate 110.

Then, as shown in FIG. 4, a first layer of optical fibers 121 are partially disposed in the first sub adhesive layer 131, such that the first layer of the optical fibers 121 are held in position in the positioning grooves 1110 of the positioning part 111, respectively.

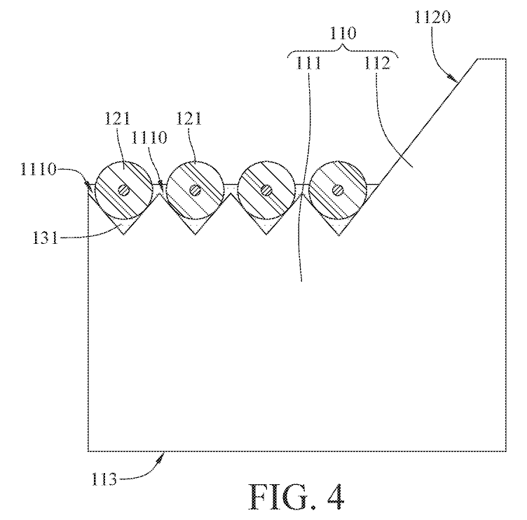

Then, as shown in FIG. 5, a second sub adhesive layer 132 and a second layer of the optical fibers 122 are disposed on the first sub adhesive layer 131 and the first layer of the optical fibers 121.

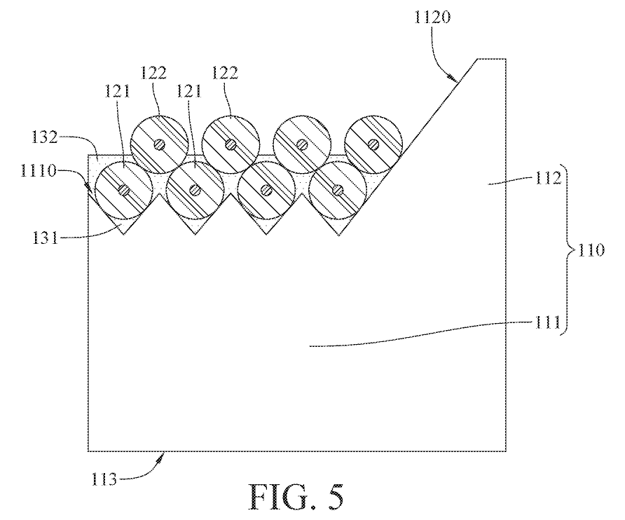

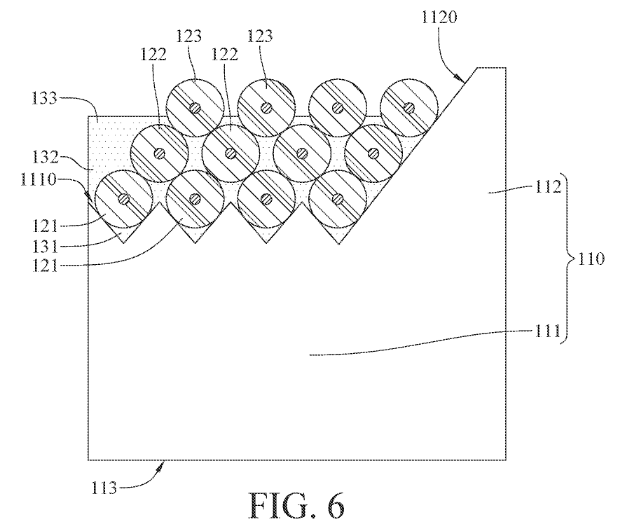

Then, as shown in FIG. 6, a third sub adhesive layer 133 and a third layer of the optical fibers 123 are disposed on the second sub adhesive layer 132 and the second layer of the optical fibers 122.

Then, as shown in FIG. 7, a fourth sub adhesive layer 134 and a fourth layer of the optical fibers 124 are disposed on the third sub adhesive layer 133 and the third layer of the optical fibers 123.

Then, as shown in FIG. 8, a fifth sub adhesive layer 135 is disposed on the fourth sub adhesive layer 134 and the fourth layer of optical fibers 124. The first sub adhesive layer 131, the second sub adhesive layer 132, the third sub adhesive layer 133, the fourth sub adhesive layer 134, and fifth sub adhesive layer 135 together configure the first adhesive layer 130. The first adhesive layer 130 is, for example, formed by curing a liquid adhesive, thereby ensuring the optical fibers 121 to 124 to be securely adhered to the carrier substrate 110. Further, the first adhesive layer 130 is, for example, formed by ultraviolet (UV) curing of a UV-sensitive adhesive. In addition, the first sub adhesive layer 131, the second sub adhesive layer 132, the third sub adhesive layer 133, the fourth sub adhesive layer 134, and the fifth sub adhesive layer 135 are, for example, disposed on the carrier substrate 110 via a dispensing process.

The layer-by-layer manner for adhering the optical fibers 121 to 124 to the carrier substrate 110 by first adhesive layer 130 as shown in FIGS. 3-8 facilitates the installation and alignment of the optical fibers 121 to 124. However, the disclosure is not limited thereto. In other embodiments, in a case that the installation and alignment of the optical fibers are not required to be considered, the whole first adhesive layer and the optical fibers may be disposed on the carrier substrate in a single step or in one go.

In addition, as shown in FIG. 8, in this embodiment, each of the optical fibers 121 to 124 includes, for example, a core 125 and a cladding 126 surrounding the core 125. At least one of the optical fibers 121 to 124 is supported by the supporting surface 1120. Furthermore, different layers of the optical fibers 121 to 124 are aligned with each other along a direction A that is perpendicular to a normal direction N of the supporting surface 1120. In other words, the cores 125 of the optical fibers 121 to 124 in different layers are aligned with each other along an alignment line L that is parallel to the supporting surface 1120. In this way, the optical fibers 121 to 124 are allowed to be more densely arranged on the carrier substrate 110, thereby further increasing the density of the optical paths.

In addition, in this embodiment, for example, there are the same number (e.g., four) of optical fibers in different layers of optical fibers 121 to 124. In some other embodiments, according to actual requirements, there may be 2 to 32 optical fibers in each layer of optical fibers. Moreover, in other embodiments, the optical fibers may be arranged in 6, 8, 12 or an arbitrary number of layers.

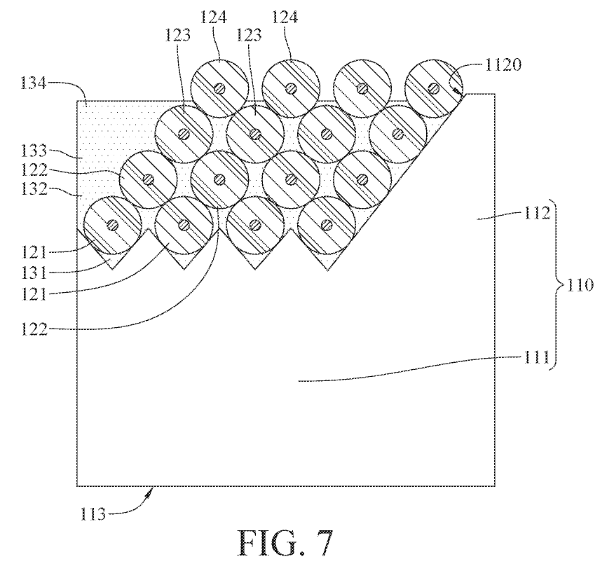

Then, as shown in FIG. 9, a cover plate 140 is disposed on the first adhesive layer 130. At least a part of the first adhesive layer 130 is located between the cover plate 140 and the supporting part 112. Further, with respect to the bottom surface 113 facing away from the optical fibers 121 to 124, the height of the supporting part 112 is lower than the height of the uppermost layer of the optical fibers 124 and the height of the first adhesive layer 130. The cover plate 140 is made of, for example, glass. So far, the manufacture of an optical fiber array 100 including the carrier substrate 110, the optical fibers 121 to 124, the first adhesive layer 130 and the cover plate 140 is completed.

Since the optical fibers 121 to 124 are arranged in layers on the positioning part 111, and at least one of the optical fibers 121 to 124 is supported by the supporting part 112, the optical fiber array 100 is allowed to include multiple layers of optical fibers 121 to 124 while precisely ensuring the alignment of the optical fibers 121 to 124. Accordingly, the density of optical paths is improved while ensuring the reliability of the installation of the optical fibers 121 to 124.

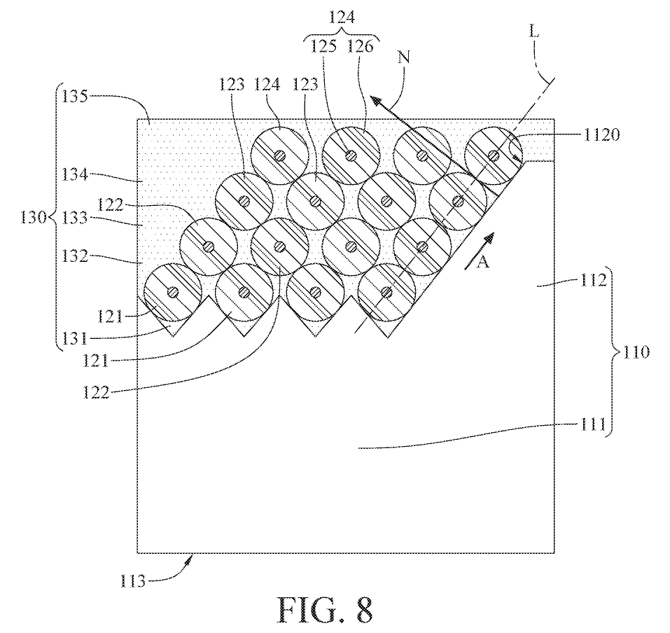

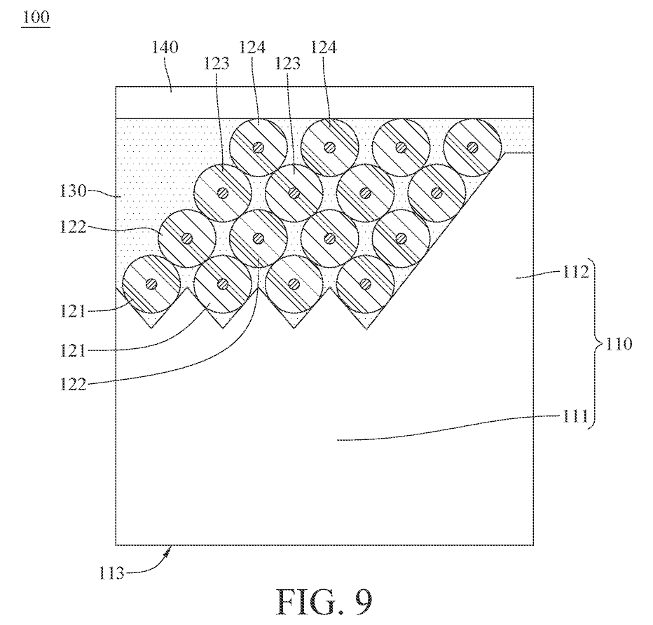

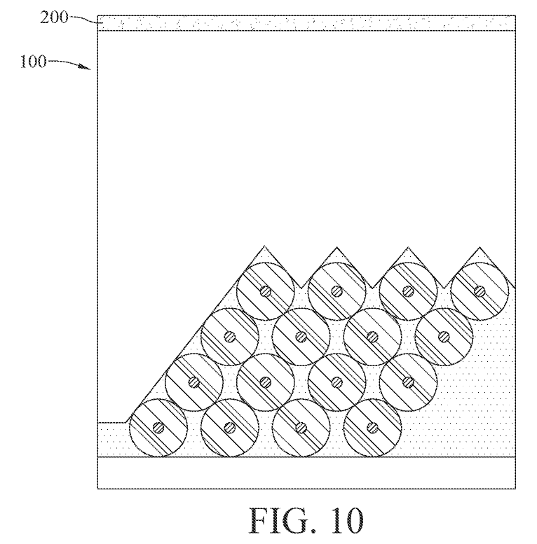

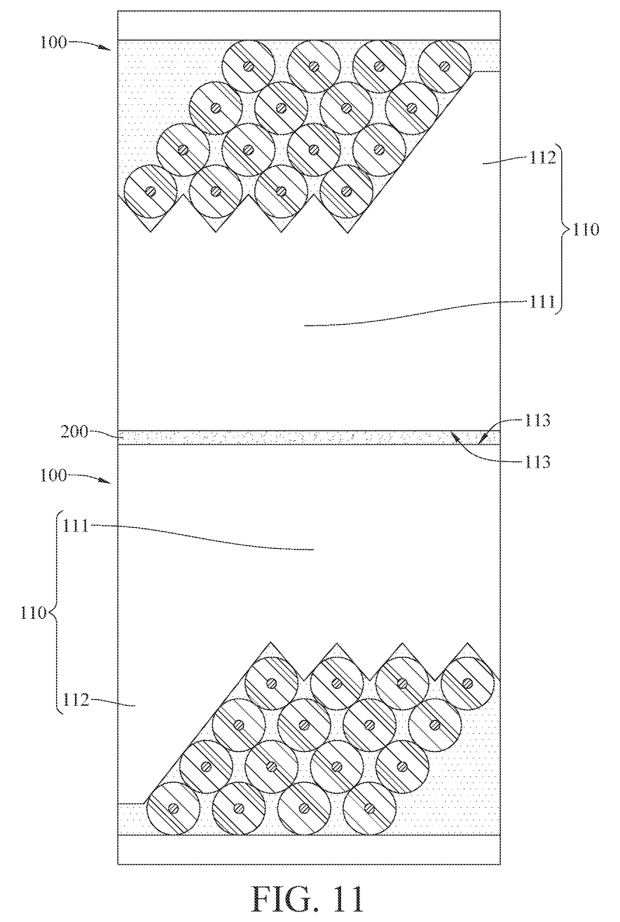

Then, as shown in FIGS. 10 and 11, another optical fiber array 100 is provided, and the two bottom surfaces 113 of the two carrier substrates 110 of the two optical fiber arrays 100 are adhered to each other via a second adhesive layer 200. The second adhesive layer 200 is in, for example, a sheet shape.

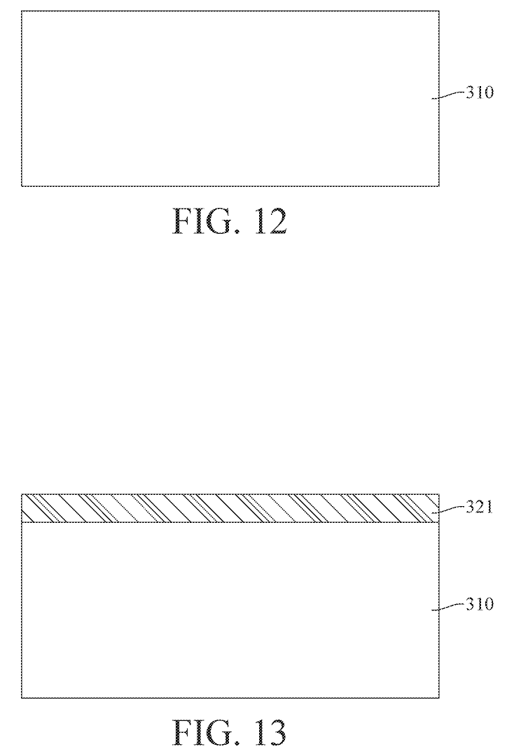

Then, as shown in FIG. 12, a substrate 310 is provided. The substrate 310 is made of, for example, glass, but the disclosure is not limited thereto. In other embodiments, the substrate may be made of materials that are less prone to deformation, such as ceramic or silicon.

Then, as shown in FIGS. 13-19, a cladding layer 320 is disposed on the substrate 310 and a plurality of cores 331 to 334 are disposed in the cladding layer 320. In this embodiment, the cladding layer 320 is disposed on the substrate 310 and the cores 331 to 334 are disposed in the cladding layer 320 both in a layer-by-layer manner. That is, in this embodiment, the step of disposing the cladding layer 320 on the substrate 310 and disposing the cores 331 to 334 in the cladding layer 320 includes, for example, following steps.

First, as shown in FIG. 13, a first sub cladding layer 321 is disposed on the substrate 310 by, for example, coating or lamination and curing.

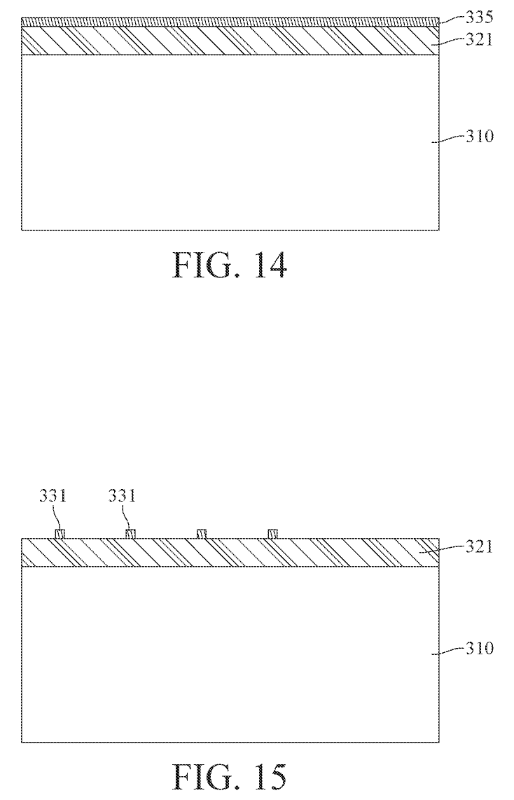

Then, as shown in FIGS. 14 and 15, for example, a first core layer 335 is disposed on the first sub cladding layer 321 via coating or lamination, and a part of the first core layer 335 is removed by lithography and curing to form a plurality of cores 331 located on the first sub cladding layer 321.

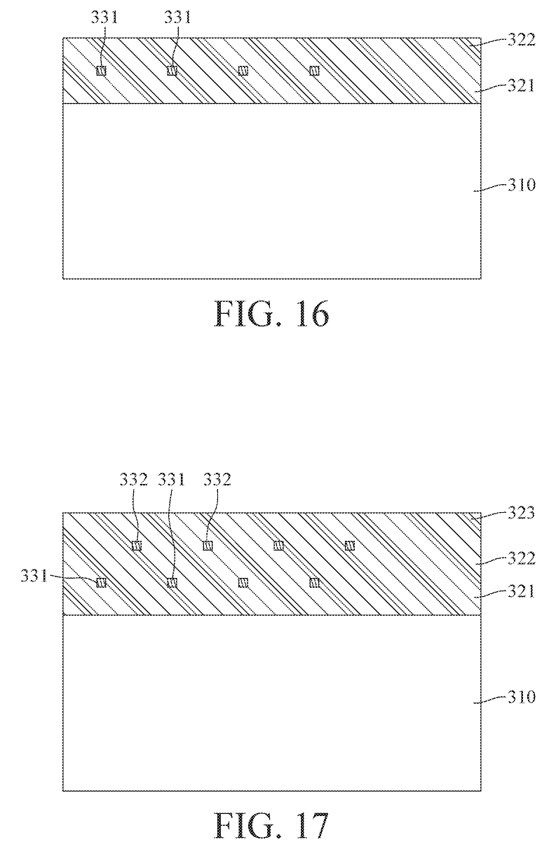

Then, as shown in FIG. 16, a second sub cladding layer 322 is disposed on the first sub cladding layer 321 and the cores 331.

Then, as shown in FIG. 17, a third sub cladding layer 323 is disposed on the second sub cladding layer 322 and a plurality of cores 332 located on the second sub cladding layer 322 are formed.

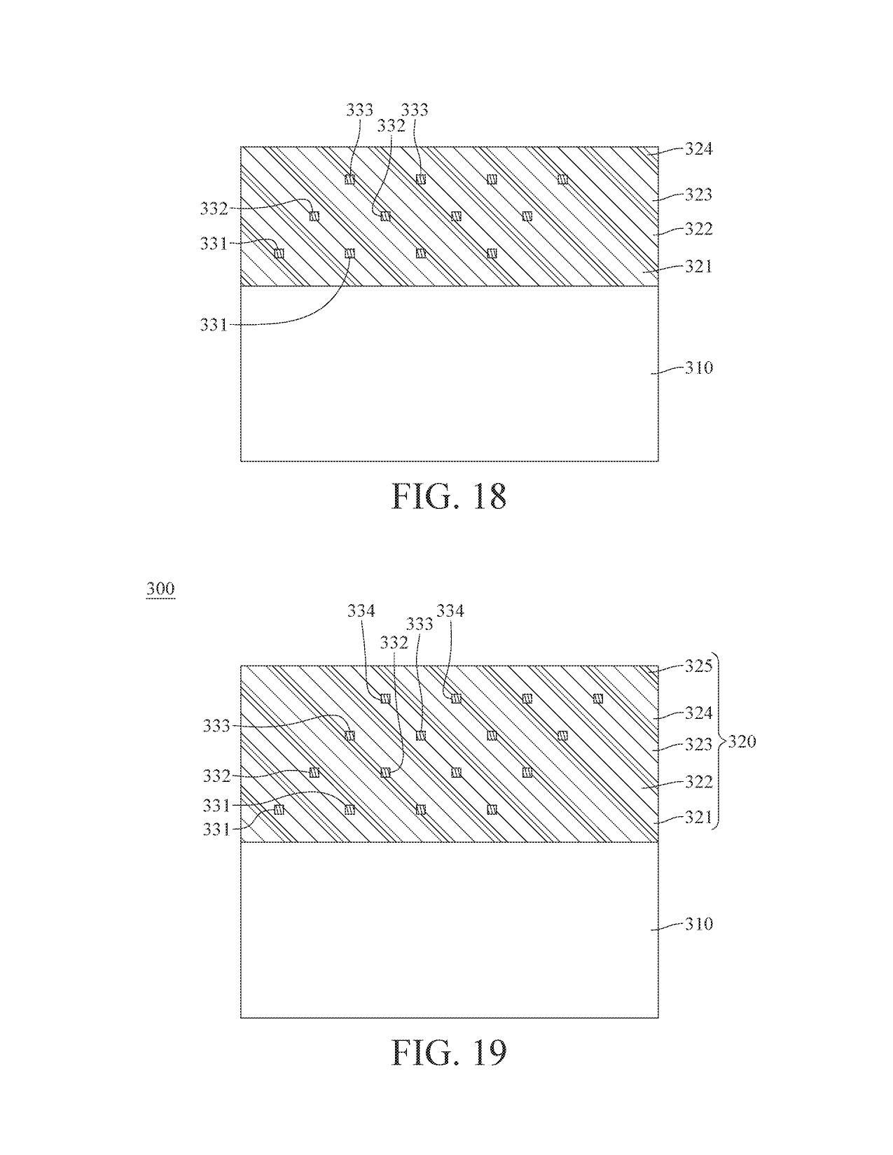

Then, as shown in FIG. 18, a fourth sub cladding layer 324 is disposed on the third sub cladding layer 323 and a plurality of cores 333 located on the third sub cladding layer 323 are formed.

Then, as shown in FIG. 19, a fifth sub cladding layer 325 is disposed on the fourth sub cladding layer 324, and a plurality of cores 334 located on the fourth sub cladding layer 324 are formed. The first sub cladding layer 321, the second sub cladding layer 322, the third sub cladding layer 323, the fourth sub cladding layer 324, and the fifth sub cladding layer 325 together configure the cladding layer 320. The cladding layer 320 is made of, for example, polymers such as polyimide (PI) or benzocyclobutene (BCB). The method for forming the cores 332 to 334 may be similar to that used for forming the cores 331, and thus is briefly illustrated in the drawings and the descriptions thereof are omitted. So far, the manufacture of a waveguide 300 including the substrate 310, the cladding layer 320, and the cores 331 to 334 is completed.

The layer-by-layer manner for disposing the cladding layer 320 on the substrate 310 and disposing the cores 331 to 334 in the cladding layer 320 as shown in FIGS. 13-19 facilitates the installation and alignment of the cores 331 to 334. However, the disclosure is not limited thereto. In other embodiment, in a case that the installation and alignment of the cores are not required to be considered, the whole cladding layer and the cores may be disposed on the substrate in a single step or in one go.

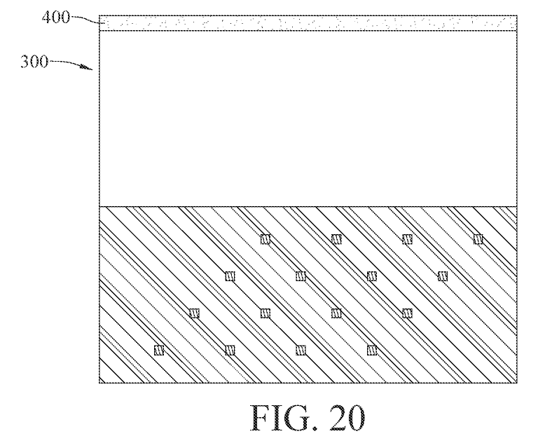

Then, as shown in FIGS. 20 and 21, another waveguide 300 is provided, and the two substrates 310 of the two waveguides 300 are adhered to each other by a third adhesive layer 400. The third adhesive layer 400 is in, for example, a sheet shape.

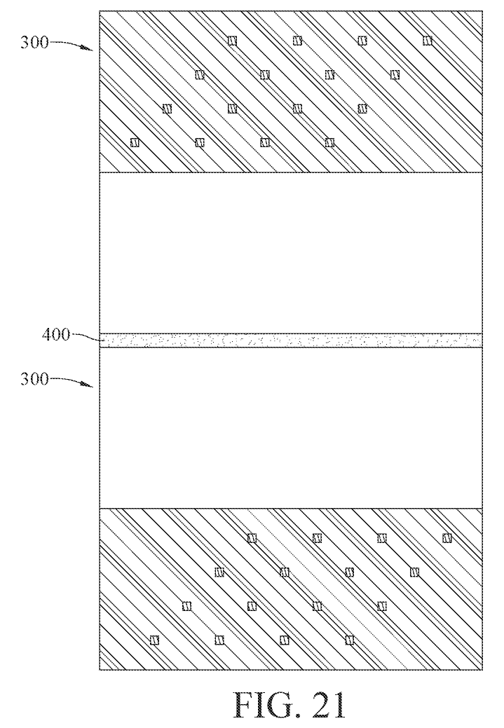

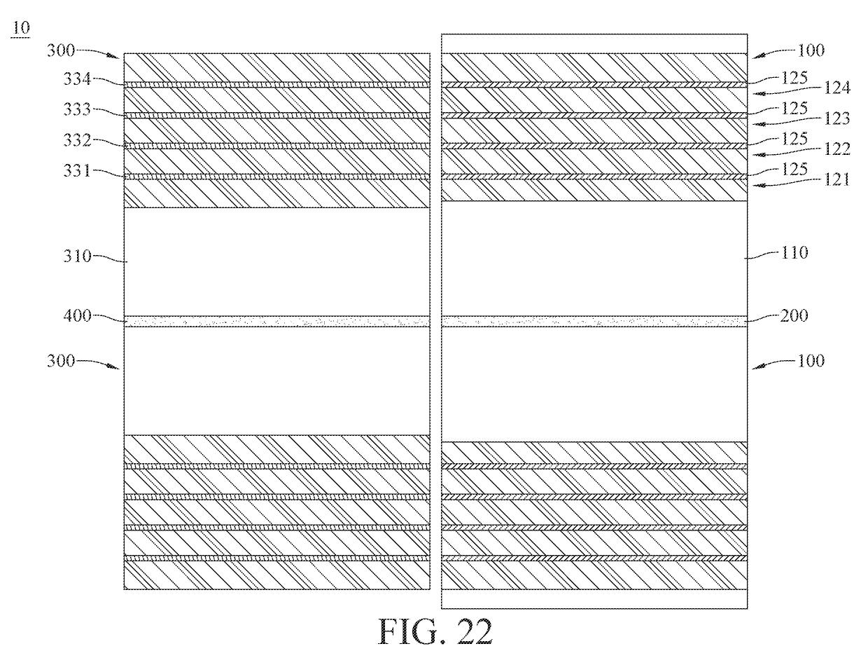

Then, as shown in FIG. 22, the cores 331 to 334 of the waveguide 300 are optically coupled to the optical fibers 121 to 124 of the optical fiber array 100, respectively. Further, the cores 125 of the optical fibers 121 to 124 are optically coupled to the cores 331 to 334 of the waveguide 300, respectively. In this embodiment, the cores 331 to 334 and the optical fibers 121 to 124, for example, have the same number and arrangement. Thus, the descriptions of the number and arrangement of the cores 331 to 334 will be omitted. So far, the manufacture of the optical coupling assembly 10 including the two optical fiber arrays 100, the second adhesive layer 200, the two waveguides 300, and the third adhesive layer 400 is completed.

Note that the carrier substrate 110 of the optical fiber array 100 and the substrate 310 of the waveguide 300 that are adjacent to each other may be assembled via engagement, any type of fit, adhering or any other suitable means. In addition, the cores 125 of the optical fibers 121 to 124 and the cores 331 to 334 of the waveguide 300 may be made of, for example, different materials.

In addition, the optical coupling assembly 10 of this embodiment includes the two optical fiber arrays 100 adhered by the second adhesive layer 200 and the two waveguides 300 adhered by the third adhesive layer 400. Therefore, the density of the optical paths of the optical coupling assembly 10 is further improved so that the optical coupling assembly 10 is allowed to cooperate with a PIC whose optical paths having higher density. However, the disclosure is not limited thereto. In other embodiments, the optical coupling assembly may include one optical fiber array 100 and one waveguide 300 according to the type of the PIC cooperating with the optical coupling assembly 10. Also, in other embodiments, the optical coupling assembly may not include the waveguide 300 according to actual design of the optical paths.

Other embodiments are described below for illustrative purposes. It is to be noted that the following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

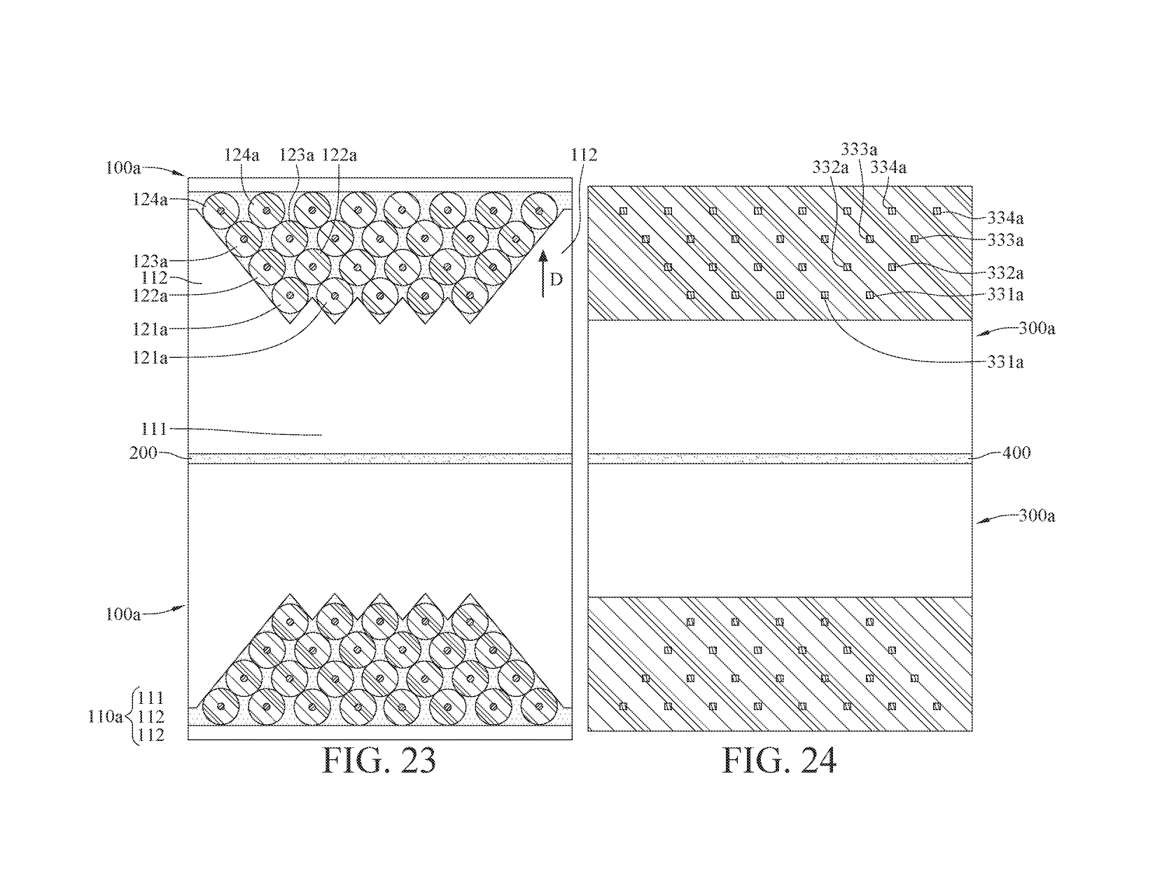

The disclosure is not limited by the arrangement of the optical fibers. The arrangement of the optical fibers may be adjusted according to the type of the PIC cooperating with the optical coupling assembly. For example, please refer to FIGS. 23 and 24. FIGS. 23 and 24 show an optical fiber array 100a and a waveguide 300a according to a second embodiment of the disclosure, respectively. The main difference between the optical fiber array 100a of this embodiment and the optical fiber array 100 of the first embodiment is the arrangement of the optical fibers 121a to 124a. As shown in FIG. 23, in this embodiment, there are different numbers of optical fibers 121a to 124a in different layers. In detail, the first layer of optical fibers 121a are located closer to the positioning part 111 than the second layer of optical fibers 122a, and the first layer of optical fibers 121a are less than the second layer of optical fibers 122a. Similarly, the second layer of optical fibers 122a is less than the third layer of optical fibers 123a, and the third layer of optical fibers 123a are less than the fourth layer of optical fibers 124a. In addition, in this embodiment, the carrier substrate 110a includes one positioning part 111 and two supporting parts 112. The two supporting parts 112 are connected to two opposite sides of the positioning part 111, respectively, and support at least one of the optical fibers 124a. Furthermore, the optical fibers 121a are located closer to the positioning part 111 than the optical fibers 123a, and at least one of the optical fibers 121a are aligned with at least one of the optical fibers 123a along a thickness direction D of the carrier substrate 110a. Also, the optical fibers 122a are located closer to the positioning part 111 than the optical fibers 124a, and at least one of the optical fibers 122a are aligned with at least one of the optical fibers 124a along the thickness direction D of the carrier substrate 110a.

In addition, as shown in FIG. 24, the arrangement of the cores 331a to 334a of the waveguide 300a in this embodiment is adjusted in a manner corresponding to that of the optical fibers 121a to 124a, and thus the repeated descriptions are omitted. It should be understood that the optical fibers 121a to 124a may be optically coupled to the cores 331a to 334a, respectively. Also, the two optical fiber arrays 100a and the second adhesive layer 200 in FIG. 23 and the two waveguides 300a and the third adhesive layer 400 in FIG. 24 may configure an optical coupling assembly.

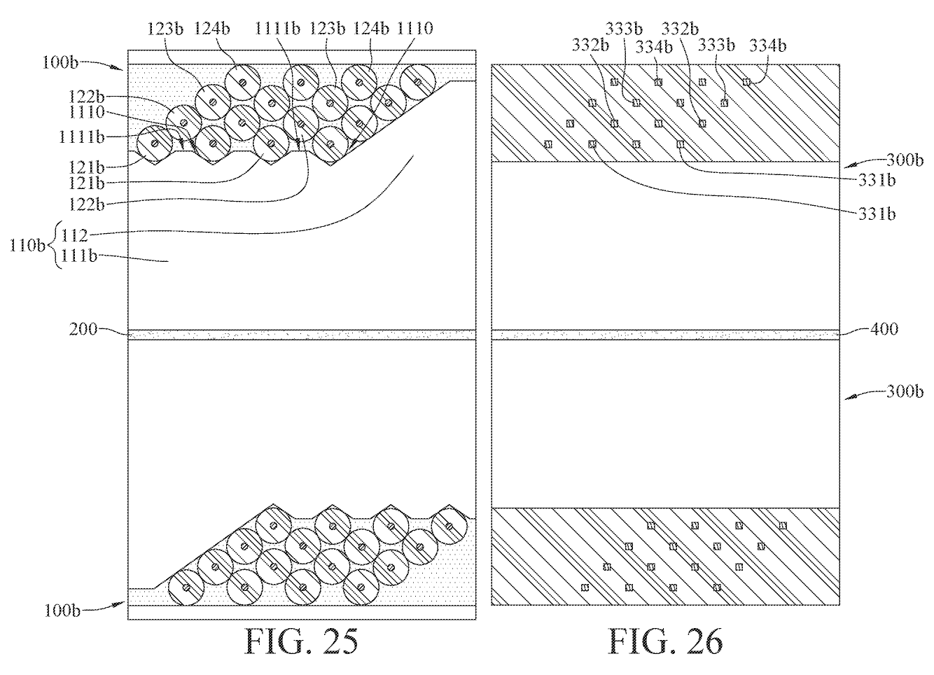

The disclosure is not limited by the gap between the optical fibers in the same layer. The gap between the optical fibers in the same layer may be adjusted according to the type of the PIC cooperating with the optical coupling assembly. For example, please refer to FIGS. 25 and 26. FIGS. 25 and 26 show an optical fiber array 100b and a waveguide 300b according to a third embodiment of the disclosure, respectively. The main difference between the optical fiber array 100b of this embodiment and the optical fiber array 100 of the first embodiment is the gap between the optical fibers 121b to 124b. As shown in FIG. 25, in this embodiment, comparing to the optical fibers 121 to 124 of the first embodiment, the gap between the same layer of optical fibers 121b, the gap between the same layer of optical fibers 122b, the gap between the same layer of optical fibers 123b and the gap between the same layer of optical fibers 124b are increased. Correspondingly, in this embodiment, the positioning part 111b of the carrier substrate 110b further has a plurality of flat surfaces 1111b located between the positioning grooves 1110.

In addition, as shown in FIG. 26, the arrangement of the cores 331b to 334b of the waveguide 300b in this embodiment is adjusted in a manner corresponding to that of the optical fibers 121b to 124b, and thus the repeated descriptions are omitted. It should be understood that the optical fibers 121b to 124b may be optically coupled to the cores 331b to 334b, respectively. Also, the two optical fiber arrays 100b and the second adhesive layer 200 in FIG. 25 and the two waveguides 300b and the third adhesive layer 400 in FIG. 26 may configure an optical coupling assembly.

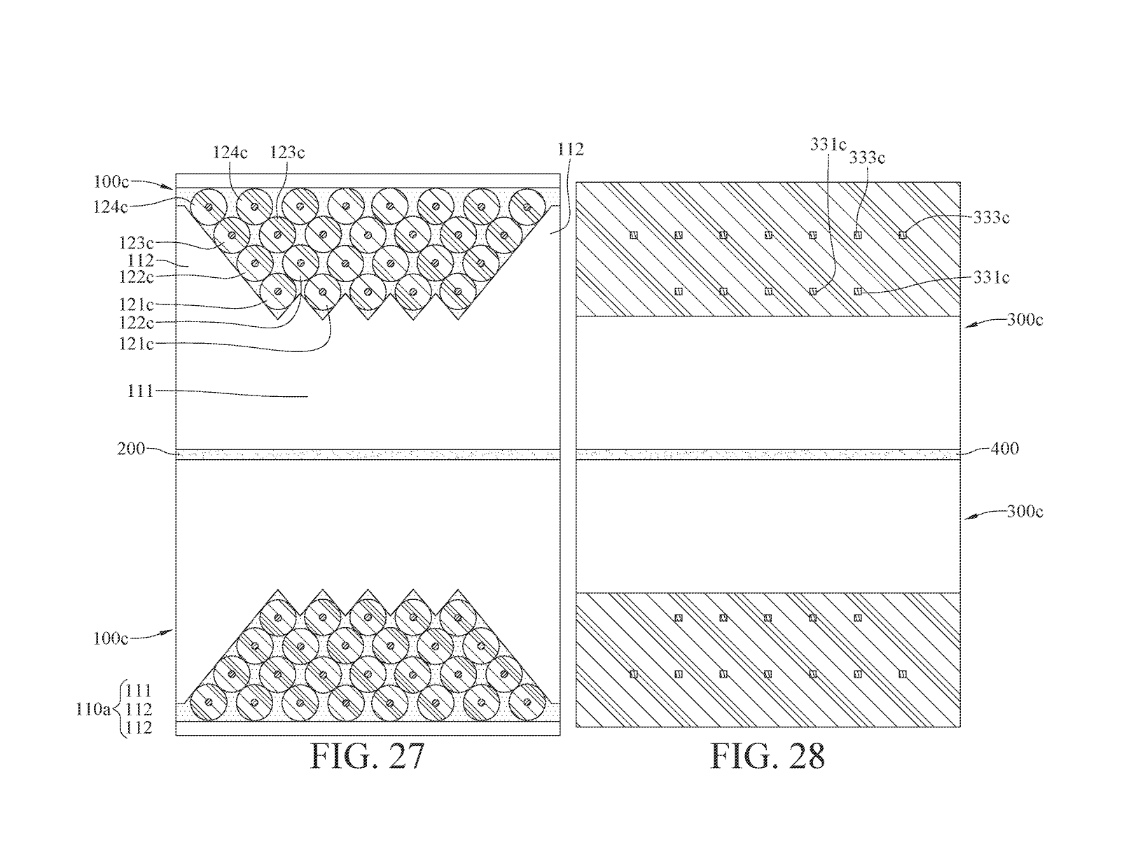

The optical fibers of this disclosure are not limited to being optically coupled to the cores of the waveguide, respectively. The cores of the waveguide may be optically coupled to a part of the optical fibers according to the type of PIC cooperating with the optical coupling assembly. For example, please refer to FIGS. 27 and 28. FIGS. 27 and 28 show an optical fiber array 100c and a waveguide 300c according to a fourth embodiment of the disclosure, respectively. The main difference between the optical fiber array 100c of this embodiment and the optical fiber array 100a of the second embodiment is the optical coupling of the optical fibers 121c to 124c. As shown in FIGS. 27 and 28, the cores 331c and 333c of the waveguide 300c are optically coupled to some layers of the optical fibers 121c to 124c, respectively. In detail, the cores 331c of the waveguide 300c are optically coupled to the optical fibers 121c, respectively, and the cores 333c of the waveguide 300c are optically coupled to the optical fibers 123c, respectively. That is, the optical fibers 122c and 124c are dummy optical fibers. Thus, during the operation, no optical signal will be transmitted to the optical fibers 122c and 124c, and there is no core in the waveguide 300c that is optically coupled to the optical fibers 122c and 124c. It should be understood that the two optical fiber arrays 100c and the second adhesive layer 200 in FIG. 27 and the two waveguides 300c and the third adhesive layer 400 in FIG. 28 may configure an optical coupling assembly.

According to the optical coupling assembly and the manufacturing method thereof disclosed by above embodiments, the optical fibers are arranged in layers on the positioning part, and at least one of the optical fibers is supported by the supporting part. Thus, the optical fiber array of the optical coupling assembly is allowed to include multiple layers of optical fibers while precisely ensuring the alignment of the optical fibers. Accordingly, the density of optical paths is improved while ensuring the reliability of the installation of the optical fibers.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An optical coupling assembly, comprising:
at least one optical fiber array, comprising:
a carrier substrate comprising a positioning part and a supporting part connected to each other, wherein the supporting part is higher than the positioning part;
a plurality of optical fibers, arranged in layers on the positioning part, wherein at least one of the plurality of optical fibers is supported by the supporting part;
a first adhesive layer, adhering the plurality of optical fibers to the carrier substrate; and
a cover plate, disposed on the first adhesive layer, wherein at least a part of the first adhesive layer is located between the cover plate and the supporting part.

2. The optical coupling assembly according to claim 1, wherein the supporting part has a supporting surface, at least one of the plurality of optical fibers is supported by the supporting surface, different layers of the plurality of optical fibers is aligned with each other along a direction perpendicular to a normal direction of the supporting surface.

3. The optical coupling assembly according to claim 1, wherein the positioning part has a plurality of positioning grooves, one of the layers of the plurality of optical fibers is held in position in the plurality of positioning grooves, respectively.

4. The optical coupling assembly according to claim 1, further comprising a second adhesive layer, wherein the positioning part and the supporting part together form a bottom surface, the bottom surface faces away from the plurality of optical fibers, the at least one optical fiber array comprises two optical fiber arrays, the two bottom surfaces of the two carrier substrates of the two optical fiber arrays are adhered to each other via the second adhesive layer.

5. The optical coupling assembly according to claim 1, wherein there is an identical number of the plurality of optical fibers in different layers.

6. The optical coupling assembly according to claim 1, wherein there are different numbers of the plurality of optical fibers in different layers.

7. The optical coupling assembly according to claim 6, wherein a first layer of the plurality of optical fibers is located closer to the positioning part than a second layer of the plurality of optical fibers, and the first layer of the plurality of optical fibers is less than the second layer of the plurality of optical fibers.

8. The optical coupling assembly according to claim 1, wherein a first layer of the plurality of optical fibers is located closer to the positioning part than a second layer of the plurality of optical fibers, and at least one of the first layer of the plurality of optical fibers is aligned with at least one of the second layer of the plurality of optical fibers along a thickness direction of the carrier substrate.

9. The optical coupling assembly according to claim 1, further comprising a waveguide comprising:
at least one substrate;
a cladding layer, disposed on the substrate; and
a plurality of cores, disposed in the cladding layer and optically coupled to at least one of the plurality of optical fibers of the optical fiber array.

10. The optical coupling assembly according to claim 9, wherein the plurality of cores of the waveguide is optically coupled to the plurality of optical fibers, respectively.

11. The optical coupling assembly according to claim 9, wherein the plurality of cores of the waveguide is optically coupled to some layers of the plurality of optical fibers.

12. A manufacturing method of optical coupling assembly, comprising:
providing a carrier substrate and processing the carrier substrate to comprise a positioning part and a supporting part connected to each other, wherein the supporting part is higher than the positioning part;
adhering a plurality of optical fibers to the carrier substrate via a first adhesive layer, wherein the plurality of optical fibers is arranged in layers on the positioning part, and at least one of the plurality of optical fibers is supported by the supporting part; and
disposing a cover plate on the first adhesive layer, wherein at least a part of the first adhesive layer is located between the cover plate and the supporting part.

13. The manufacturing method of optical coupling assembly according to claim 12, further comprising:
providing a substrate;
disposing a cladding layer on the substrate and disposing a plurality of cores in the cladding layer; and
optically coupling the plurality of cores to at least one of the plurality of optical fibers.

14. The manufacturing method of optical coupling assembly according to claim 13, wherein adhering the plurality of optical fibers to the carrier substrate via the first adhesive layer comprising:
disposing a first sub adhesive layer on the carrier substrate;
disposing a first layer of the plurality of optical fibers in the first sub adhesive layer partially so that the first layer of the plurality of optical fibers is disposed on the positioning part;
disposing a second sub adhesive layer and a second layer of the plurality of optical fibers on the first sub adhesive layer and the first layer of the plurality of optical fibers; and
disposing a third sub adhesive layer on the second sub adhesive layer and the second layer of the plurality of optical fibers.
